(19) United States
(12) Patent Application Publication
(10) Pub. No.: US 2010/0019612 A1
(43) Pub. Date: Jan. 28, 2010

(54) FLUX IMPULSE MOTOR

(75) Inventor: Paul Lefley, Leicester (GB)

Correspondence Address: Studebaker & Brackett PC, One Fountain Square, 11911 Freedom Drive, Suite 750, Reston, VA, 20190, US

(73) Assignee: SYNCHROPULSE LIMITED, Lincoln (UK)

(21) Appl. No.: 12/442,339

(22) PCT Filed: Sep. 24, 2007
(86) PCT No.: PCT/GB2007/003611

§ 371 Date: Mar. 20, 2009

(30) Foreign Application Priority Data
Sep. 22, 2006 (GB) 0618729.8

(51) Int. Cl. H02K 1/14

(52) U.S. Cl. 310/216.076

(57) ABSTRACT

A motor 1 comprises a stator 2, a rotor 10 mounted for rotation about a rotor axis 50 in the stator 2, a pole 11 of the stator 2, a winding on the stator pole 11, and at least one pair of salient poles 10a-d of the rotor 10. The rotor 10 is magnetised so that said rotor poles 10a-d are oppositely magnetised. The motor 1 further comprises an electrical circuit being provided with control means to produce an alternating magnetic field in the pole 11 of the stator 2 to attract each pole 10a-d of the rotor 10 as it approaches the pole 11 and to repel each pole 10a-d of the rotor 10 as it moves away from the pole 11, said field alternating as many times per revolution of the rotor 10 as there are poles of the rotor 10. Each pole 10a-d of the rotor 10 is magnetised by a permanent magnet 72 carried by said pole 10a-d, wherein the magnet 72 has a magnet axis of magnetisation 80, which magnet axis 80 is inclined with respect to a radial direction 82 of said rotor axis 50.

The present invention relates to electric motors of the brushless type.

The present invention is a modification of that disclosed in WO-A-02/101907, the contents of which are hereby incorporated by reference.

A paper by Deodhar, R. P. et al, “The Flux-Reversal Machine: A New Brushless Doubly-Salient Permanent Magnet Machine” IEEE 1996, (“Deodhar”) discloses a machine comprising:

a stator;

a rotor mounted for rotation in the stator;

first and second poles of the stator;

a winding on at least one of the stator poles;

at least one pair of salient poles of the rotor;

an outer back-iron magnetically joining said stator poles; and

an inner back-iron, extending from at least one of said stator poles around the rotor so that the magnetic field in the rotor between adjacent poles of the rotor is at least partially short-circuited by said inner back-iron for a part of the rotation of the rotor.

Permanent magnets are provided on the stator poles, which are identical with one another. The machine can only operate as a motor provided it is arranged in a multiphase configuration. When it does so, it performs as a standard reluctance motor.

In accordance with the invention of WO-A-02/101907, there is provided a motor of the type described in Deodhar, characterised by:

an electrical circuit to power the winding to drivingly rotate the rotor;

the first pole of the stator being a commutating pole and not short-circuiting the rotor;

said second pole of the stator being a field connecting pole (12) and having said inner back iron;

the rotor being magnetised so that said rotor poles are oppositely magnetised, said electrical circuit being provided with control means to produce an alternating magnetic field in the commutating pole of the stator to attract each pole of the rotor as it approaches the commutating pole and to repel each pole of the rotor as it moves away from the commutating pole, said field alternating as many times per revolution of the rotor as there are poles of the rotor; whereby

the rotor is driven by a combination of electromagnetic torque through interaction between the rotor and the commutating pole and by reluctance torque through interaction between the rotor and the field-connecting pole.

The short-circuiting of the magnetic field through the rotor by the inner back-iron provides a low reluctance path which has both a positive and negative impact on the torque applied to the rotor. The effect is positive when reducing reluctance is experienced, as the short-circuiting commences, and torque is applied to the rotor, but is negative when the short-circuiting ceases and an equivalent negative torque is applied. This has a smoothing effect on the overall torque curve since the negative effect can be arranged to coincide with the main driving “pulse” of the motor. This reduces the size of the driving pulse, which is instead seen “translated” into the positive effect of the short-circuited field.

The poles of the stator are preferably salient. The commutating winding may be around the commutating pole of the stator. A field winding might be provided around the field-connecting pole. Moreover, the commutating and field windings may be in series. Indeed, the field winding could develop a larger magnetic field than the commutating winding.

Preferably, the angular extent of adjacent poles of the rotor is substantially the same as the angular extent of the inner back-iron, which angular extent is substantially (270/n)°, where n is the number of rotor pole pairs. By “angular extent” is meant the angle of the segment(s) of a circle that includes both said poles of the rotor, or, in the case of the inner back-iron, the inner back-iron.

Preferably, the angular extent of one of said poles of the rotor is about the same as the angular extent of the commutating pole, and is preferably substantially (90/n)°, where n is the number of rotor pole pairs. Preferably, said poles of the rotor have a varying radius across their angular extent such that said poles are short-circuited over an angle α equal to substantially (45/n)°, where n is the number of rotor pole pairs. When there is just one of said pole pairs, then said angle α is about 45°.

Preferably, there are an equal plurality each of commutating and field-connecting poles alternately disposed around the stator, and twice as many poles of the rotor as there are field-connecting poles. Indeed, there may be two field-connecting poles, two commutating poles and a cross shaped rotor having two pole pairs. In this event, the angle a is about 22°.

When the rotor is cross-shaped with two pole pairs, the poles are alternately magnetised. Such an arrangement is preferable from a torque perspective but requires an electrical circuit having at least two switches in order to change the direction of magnetisation of the commutating pole (as many times per revolution as there are poles of the rotor).

The present invention relates to improvements in the design of such a motor in particular, but may have wider applications in other motors.

It is an object of the present invention to provide a motor in which the rotor is permanently magnetised wherein the magnet is located in a convenient manner.

Thus, in accordance with the present invention there is provided a motor comprising:

a stator;

a rotor mounted for rotation about a rotor axis in the stator;

a pole of the stator;

a winding on the stator pole;

at least one pair of salient poles of the rotor, the rotor being magnetised so that said rotor poles are oppositely magnetised;

an electrical circuit being provided with control means to produce an alternating magnetic field in the pole of the stator to attract each pole of the rotor as it approaches the pole and to repel each pole of the rotor as it moves away from the pole, said field alternating as many times per revolution of the rotor as there are poles of the rotor; and

each pole of the rotor being magnetised by a permanent magnet carried by said pole; wherein

the magnet is disposed in a transverse slot in each pole.

By locating the magnet in a transverse slot no other form of location is required. The slot can be fashioned to accommodate the magnet in a close sliding fit so that, once installed, no other form of fixing is required.

Preferably, said rotor comprises a stack of laminations connected together. In that event, preferably, in a cross section of the rotor perpendicular to said rotor axis, said slot is closed. Thus the magnet is introduced into the slot by sliding it into the slot in an axial direction with respect to the rotor axis. Since ligaments at either end of the slot connect the root of the rotor to a distal rotor tip around the slot across most of its width, the structure of the rotor is strong in a radial direction. However, if the ligaments are too thick, excessive short-circuiting of the magnet's flux may occur, diminishing the effective magnetisation of the magnet. This effect can be counteracted by minimising the thickness of the ligaments consistent with the strength requirement of the connection between the root and tip, and by broadening the root of the rotor so that a longer (wider) magnet can be employed and so that the remaining magnetic flux (left after the ligaments have been saturated with the short-circuiting flux) is equivalent to the flux available in a sufficiently strong magnet for the motor purposes when no ligaments short-circuit the magnet.

However, more preferably, in cross section in a plane perpendicular said rotor axis, said magnet is inclined with respect to a tangent of the circle that is centred on the rotor axis, which tangent is that perpendicular to the radius that passes through the centre of the pole, said angle of inclination being between 5° and 40°. Such an arrangement has two effects.

The first is that a longer (wider) magnet can be employed, so that the benefits described above can be experienced without the need to broaden the roots of the rotor poles (which incidentally may be difficult to achieve in four pole rotors). Secondly, such an arrangement has the effect of biasing the flux density in the rotor so that, on start-up of the motor in any given start position, the direction of rotation of the rotor is more easily assured to be in the direction desired.

Indeed, in another aspect, it is also an object of the present invention to provide a motor in which the direction of rotation of the motor on start-up of the motor can generally more easily be assured.

Thus, in accordance with the present invention there is provided a motor comprising

a stator;

a rotor mounted for rotation about a rotor axis in the stator;

a pole of the stator;

a winding on the stator pole;

at least one pair of salient poles of the rotor, the rotor being magnetised so that said rotor poles are oppositely magnetised;

an electrical circuit being provided with control means to produce an alternating magnetic field in the pole of the stator to attract each pole of the rotor as it approaches the pole and to repel each pole of the rotor as it moves away from the pole, said field alternating as many times per revolution of the rotor as there are poles of the rotor; and

each pole of the rotor being magnetised by a permanent magnet carried by said pole; wherein

in cross section in a plane perpendicular said rotor axis, said magnet is inclined with respect to a tangent of the circle that is centred on the rotor axis, which tangent is that perpendicular to the radius that passes through the centre of the pole, said angle of inclination being between 10° and 40°.

Preferably said magnet is parallel to said rotor axis. Preferably, said angle of inclination is between 10° and 30°, preferably between 15° and 25°.

A motor as defined in either foregoing aspect of the present invention, in a cross section of the rotor perpendicular to said rotor axis, said rotor pole may have a width across the radius that passes through the centre of the pole, and said magnet may extend across most of the width of said rotor.

Indeed, when according to both or just the first aspect, and wherein ligaments of each rotor lamination define each end of the slot, said ligaments being sufficient to support a distal pole tip part of each lamination with respect to a proximal root of each lamination and retain the magnet in the slot while minimising the flux short-circuiting of the magnet caused by said ligament.

Preferably, said rotor has an end face and sides defining leading and trailing corners of the rotor in the direction of rotation of the rotor.

Preferably, said magnet has one end adjacent to said trailing corner, whereby the magnetisation of the magnet magnetically saturates the rotor in the region of said trailing corner, and another end which is spaced from the leading corner which is not magnetically saturated.

Preferably, said motor is a motor as described in WO-A-02/101907.

By inclining the magnet as defined above, the magnetic shape of the rotor is altered, biasing it preferentially to rotate in the direction of inclination. In this respect, the direction of inclination is the direction from the most radially remote end of the magnet with respect to the rotor axis towards the more radially close end of the magnet with respect to the rotor axis.

It is a further object of the present invention to provide a motor of the type described in WO-A-02/101907 with reduced torque ripple during rotation.

In accordance with this aspect of the invention, there is provided a motor comprising:

a stator;

a rotor mounted for rotation about a rotor axis in the stator;

first and second poles of the stator;

a winding on at least one of the stator poles;

at least one pair of salient poles of the rotor, the rotor being magnetised so that said rotor poles are oppositely magnetised;

an outer back-iron magnetically joining said stator poles;

an inner back-iron, extending from at least one of said stator poles around the rotor so that the magnetic field in the rotor between adjacent poles of the rotor is substantially short-circuited by said inner back-iron for a part of the rotation of the rotor; and

an electrical circuit to power the winding to drivingly rotate the rotor; wherein

said first pole of the stator being a commutating pole and not short-circuiting the rotor;

said second pole of the stator being a field connecting pole (12) and having said inner back iron;

said electrical circuit being provided with control means to produce an alternating magnetic field in the commutating pole of the stator to attract each pole of the rotor as it approaches the commutating pole and to repel each pole of the rotor as it moves away from the commutating pole, said field alternating as many times per revolution of the rotor as there are poles of the rotor; whereby

the rotor is driven by a combination of electromagnetic torque through interaction between the rotor and the commutating pole and by reluctance torque through interaction between the rotor and the field-connecting pole,

characterised in that

the inner back iron is substantially circumferential with respect to the rotor axis and has end sectors adjacent its ends and an intermediate sector between said end sectors, which intermediate sector is spaced further from said rotor axis than said end sections.

Preferably, most of said intermediate sector is in a leading part of said inner back iron with respect to the direction of rotation of the rotor.

Preferably, said end sectors are a leading end sector and a trailing end sector with respect to the direction of rotation of the rotor and said intermediate sector has a trailing junction with said trailing sector, which trailing junction is on the radius of said rotor axis passing through said field connecting pole, preferably through the centre of said field connecting pole.

Preferably, the intermediate sector has a leading junction with the leading end sector positioned so that the circumferential extent of the intermediate sector is between 70% and 130% of the circumferential extent of the leading end sector, preferably between 90% and 110%.

The rotor has an end face having a leading section extending from a leading edge of the rotor with respect to the direction of rotation of the rotor, and a trailing section extending from a trailing edge of the rotor with respect to the direction of rotation of the rotor.

Preferably, the extent of the leading end sector and the intermediate sector is the same as the circumferential extent of the end face of each rotor pole.

Preferably, the leading section is spaced nearer the rotor axis than the trailing section. Preferably, the end face is a circular arc centred on an axis parallel to and spaced from said rotor axis. Preferably, the radius of said trailing section is between 2% and 10% more than the radius of said leading section, preferably between 3% and 6%.

Preferably, said trailing edge defines a minimum air gap between the rotor and inner back iron, which air gap, when said trailing edge is adjacent either end sector, is between 20% and 70% of the air gap when said trailing edge is adjacent said intermediate sector, preferably between 40% and 60%. Put another way, preferably, the radius of the intermediate sector is preferably between 1% and 3% more than the radius of said end sectors.

Said increased air gap presented by said intermediate sector has the effect of increasing the reluctance thereof and is arranged to retard the rotor when said leading edge of the rotor passes over said leading junction and to accelerate said rotor when said leading edge passes over said trailing junction, said retardation being arranged during a period of highest electromagnetic torque generated by interaction between the commutating pole and the rotor and said acceleration being arranged during a period of lowest electromagnetic torque generated by interaction between the commutating pole and the rotor, whereby the torque ripple of the motor is minimised.

The invention is further described hereinafter, by way of example, with reference to the accompanying drawings in which:

Figures A to D are schematic diagrams of a known motor, not forming part of the present invention;

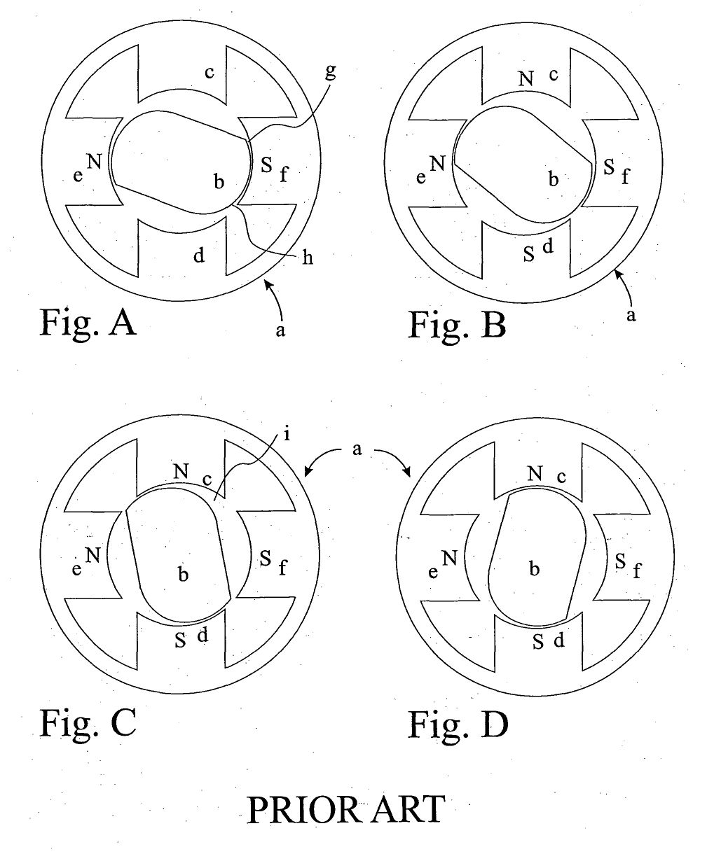

FIGS. 1a to d are schematic diagrams of a motor having a two-pole rotor, in each drawing the rotor being in a different angular position;

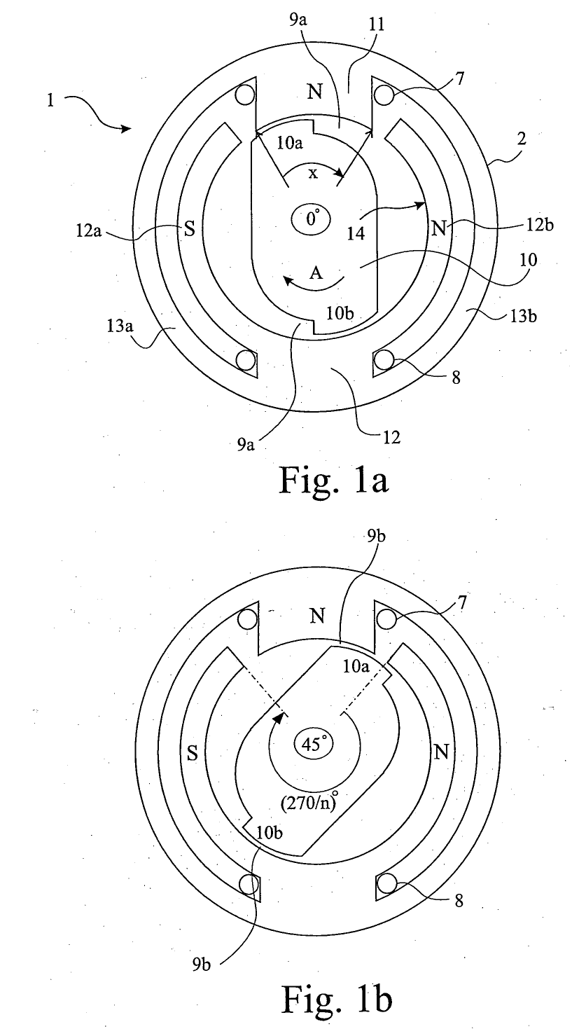

FIGS. 2a to d are the same as FIGS. 1a to d, except here the motor is in accordance with the invention of WO-A-02/101907, and in which the rotor is permanently magnetised;

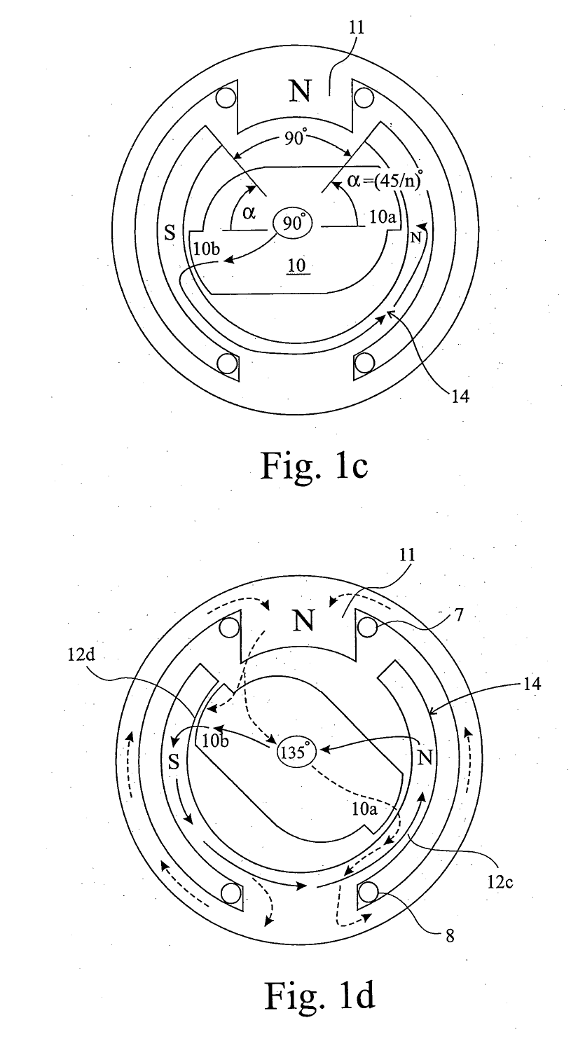

FIGS. 3a to c are similar views of a further embodiment of the invention of WO-A-02/101907, and in which a four-pole rotor is employed having alternate permanent magnetisation of its poles;

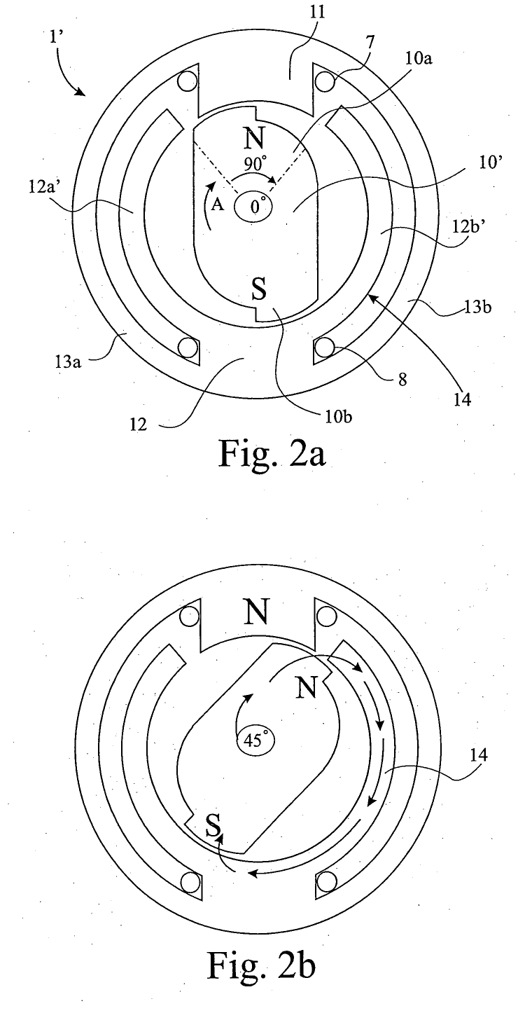

FIG. 4 is a similar view to FIG. 3c, except that here, like FIGS. 1a to d, the rotor is not magnetised, permanent magnetisation being incorporated in the stator;

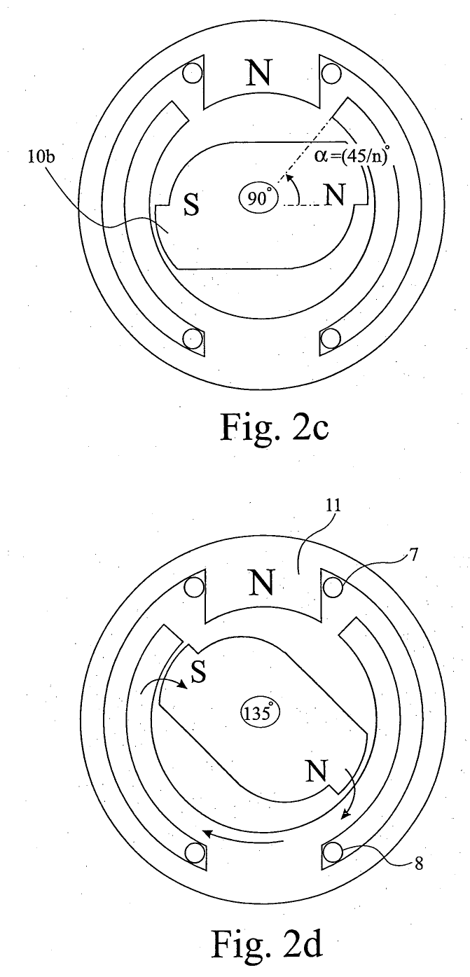

FIG. 5 is a view similar to FIG. 4 of a simpler motor;

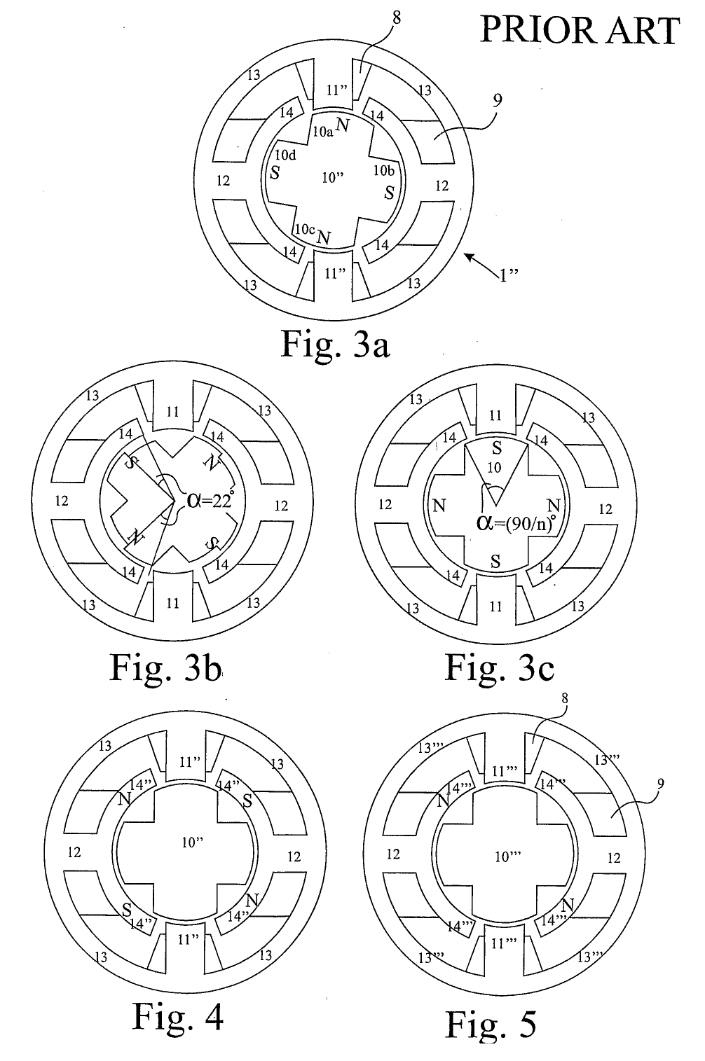

FIGS. 6a and b are torque curves for the motors of FIGS. 5 and 3 respectively.

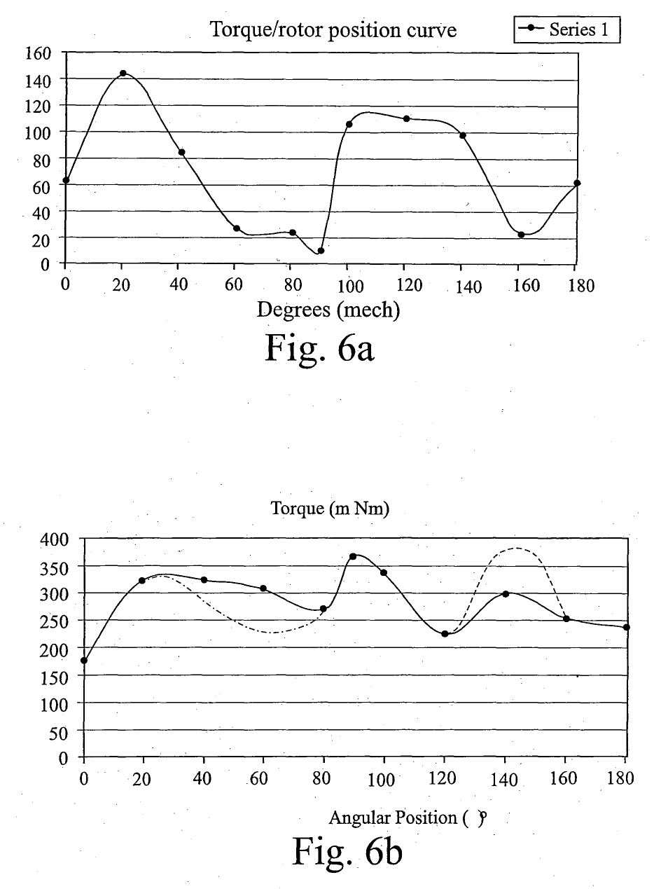

FIGS. 7a and b are different circuit arrangements for powering the motors of FIGS. 2 and 3;

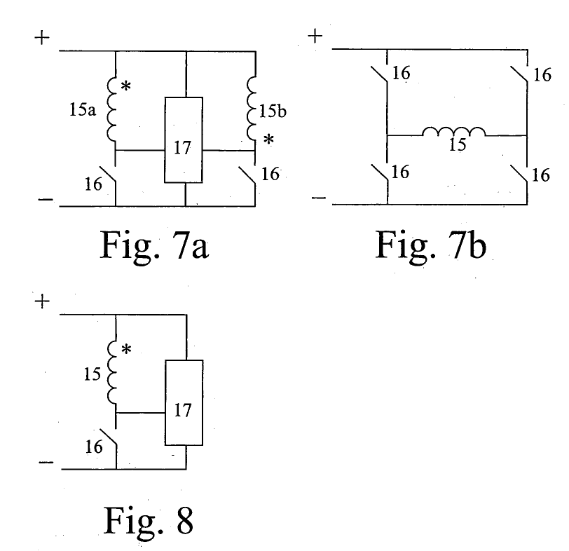

FIG. 8 is a circuit arrangement for powering the motors of FIGS. 1, 4 and 5;

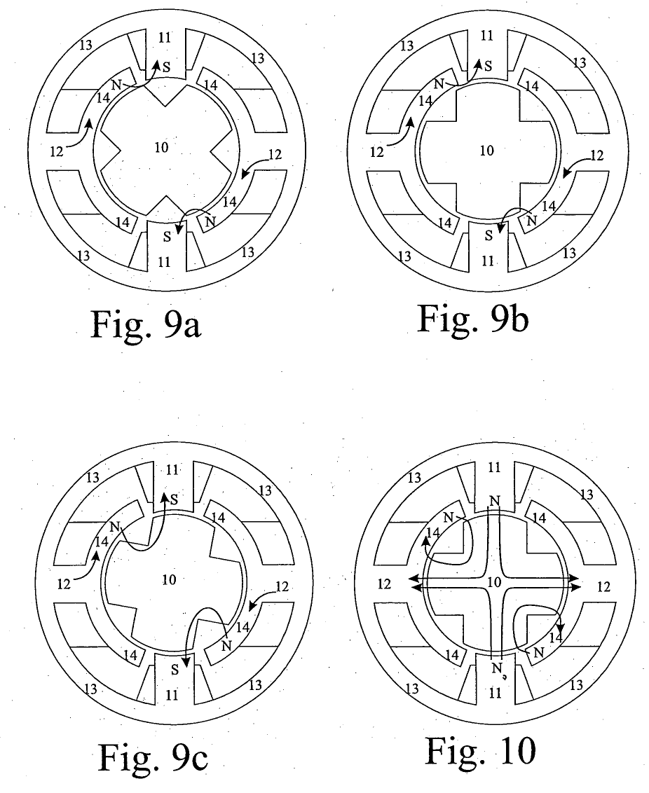

FIGS. 9a to c show the flux distribution of the motor of FIG. 5 when a south pole is formed at the commutating poles;

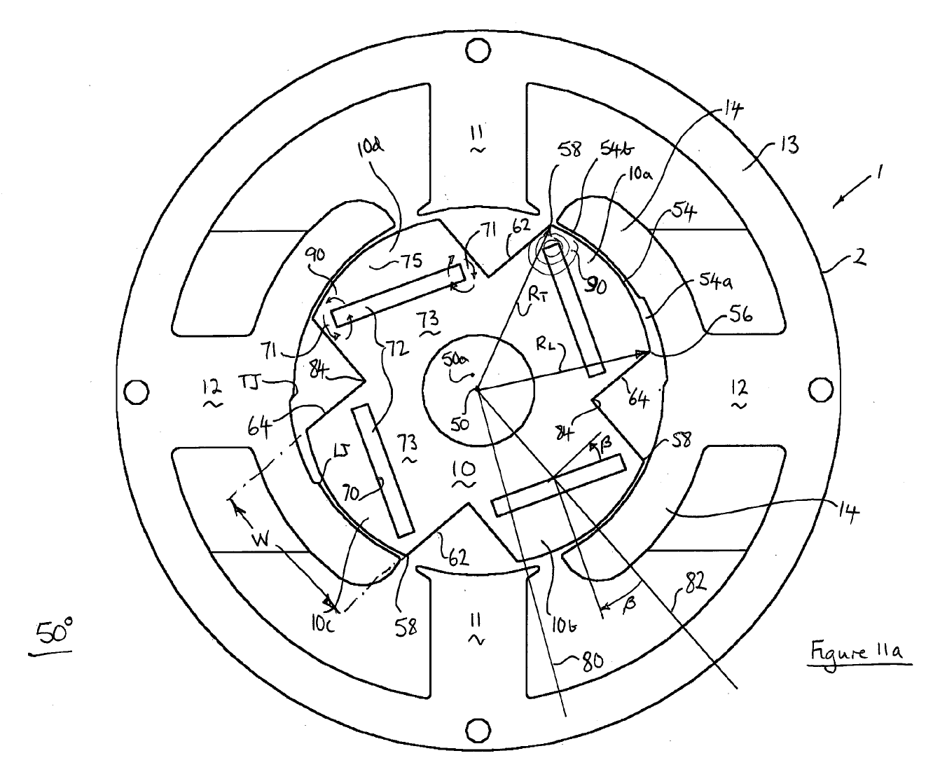

FIG. 10 shows the flux distribution of the motor of FIG. 5 when a north pole is formed at the commutating poles;

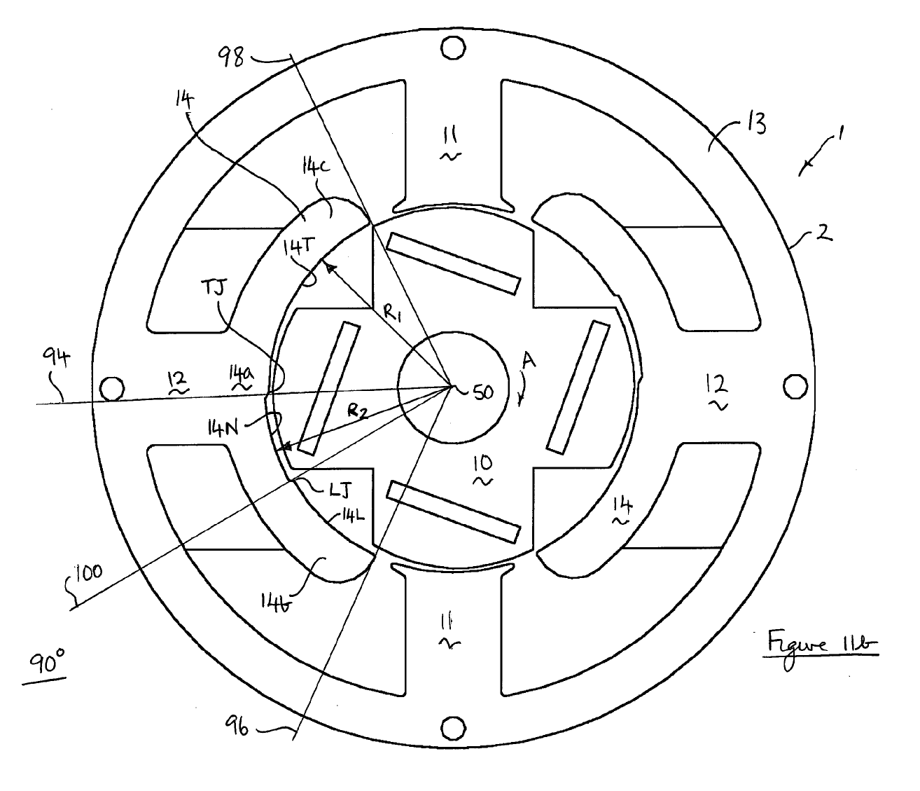

FIGS. 11a and b are sections through a motor in accordance with the present invention in two different rotor positions of 50° and 90° respectively.

Figure A shows a basic arrangement of a known two pole flux impulse motor a, comprising a two pole rotor b, a stator consisting of two commutating poles c and d, and two field poles e and f. The field poles may either be permanently magnetised with one possible arrangement (as shown) or there is a field winding (around the field poles) with a dc current flowing to produce the magnetisation shown. Coils (not shown) are wound around the commutating poles to form a winding called the commutating winding. The poles g of the rotor may not have a constant radius arc at the pole extremities. Instead, a tapering curved leading edge h of the poles is provided, such that the radial air gap i created between the poles of the rotor and any of the stator poles varies during rotation. There may also be other features of the rotor poles to enhance the asymmetry of the two rotor poles. For example, instead of the (preferred) infinitely varying gap i shown in Figures A to D, a step or shoulder may be formed at the pole tip.

In the absence of a current in the commutating winding the rotor is at a position of rest as shown in Figure A. If a dc current is applied to the commutating winding a field is created on the commutating poles with a north pole on pole c and a south pole on pole d (see Figure B). As a result of the field, the rotor b rotates from a position of rest to another position of equilibrium shown in Figure B. If the magnitude of the current in the commutating winding is increased, then the rotor rotates further to another position of equilibrium, for example as shown in Figure C. If the current in the commutating winding is now switched off, (and in the absence of any rotational inertia of the rotor in a clockwise sense), the rotor may rotate anticlockwise and settle in the initial position of equilibrium shown in figure A.

This demonstrates a possible starting problem with this type of motor. In order to ensure that the motor is able to start up from rest and accelerate, the magnitude of the magnetic field produced at the commutating poles has to be much greater than the permanent field produced by the field poles. To ensure a continuous rotation, the commutating poles must pull the rotor to the position shown in Figure D. In this position, and upon releasing the current in the commutating winding, the field poles will pull the rotor clockwise to the position shown in Figure A (completing a rotation of 180 degrees).

Clearly a large pulse of current is required to start the motor, or the magnitude of the permanent field needs to be weak, at least in order to avoid excessive currents. As soon as the rotor is rotating at some speed, large impulses of flux produced at the commutating poles pull the rotor from the field alignment flux. The inertia of the rotor (and some torque produced by the field alignment flux) carries the rotor to the next commutation position. Thus the current in the commutating winding is not continuous and has a duty of typically around 50%.

To ease the starting and running problems it may be advantageous to switch off the field at certain times. However, this means that permanent magnets may not be used to produce the field flux, and that there must be appropriately timed commutation of the field winding current, in addition to the commutating winding current. This adds extra complexity to the design of the motor and the power electronics.

Turning to FIG. 1 of the drawings, a motor 1 comprises a stator 2 and a rotor 10 mounted for rotation within the stator 2.

The stator 2 has a commutating pole 11 and a field pole 12. The stems or bases of the commutating pole 11 and field pole 12 are joined by an outer back-iron 13a,b. The commutating pole 11 has a commutating winding 7 which is in series (or parallel) with a field winding 8 on the field pole 12. However, there may be some advantage in keeping the commutating pole coils 7 separate from the field connecting pole coils 8.

The angular extent x of the commutating pole 11 is about 90°. The rotor 10 has two salient poles 10a,b, the angular extent of which is likewise about 90°. Each pole is provided with a shoulder so as to provide an enlarged air gap 9a on the leading edge of the rotor, and a thin air gap 9b on the trailing edge of the rotor. This enlarged air gap 9a ensures rotation of the rotor 10 in the direction of the arrow A. It means that flux connection between the rotor occurs over only about half the angular extent of the rotor, ie about 45°. Although shown as a step, it is preferred that an arrangement similar to that shown in Figures A to D is employed which provides a smoother transition between flux connection and isolation. For convenience, however, a stepped shoulder is shown here, and nothing at all is shown in FIGS. 3 to 5, and 9 and 10, below.

The field pole 12 is provided with two limbs 12a,b which, between them, define an inner back-iron 14. The angular extent of the inner back-iron is about 270°. As mentioned above, the poles 10a,b of the rotor (ie, those parts presenting the minimum air gap 9b with the stator poles) subtend an angle of about 45° each. Accordingly, as can be seen in FIGS. 1c and d, the angle a of rotation of the rotor over which both poles 10a,b of the rotor 10 lie adjacent the back-iron 14 (ie are short-circuited by it) is about 45°.

In operation, the rotor 10 is rotating in the direction of the arrow A in FIG. 1a. That Figure shows the rotor 10 in the zero angle position. In this position there is excitation of the commutating coils 7 and a north pole is presented at the commutating pole 11. With reference also to the torque curve in FIG. 6a, it can be seen that, in the zero position there is a small positive torque. This is because the minimum reluctance position has not yet arrived but occurs at about 15°, at which point, the power to the windings 7,8 is turned off. The rotor is then drawn with high torque being applied by the magnetisation of the limb 12b of the back-iron 14. This torque is applied until the minimum reluctance position of the rotor 10 within the confines of the back-iron 14 is achieved at about 100°, as shown in FIG. 1c.

However, at about 90°, ie before the minimum reluctance position is reached, the windings 7,8 are re-energised and a positive torque is applied as the pole 10b is attracted by the strong field produced by the commutating and field coils 7,8. Torque therefore continues to be applied to the rotor until beyond the 180° position, which corresponds with the zero position of FIG. 1a. The cycle thereafter repeats each 180 mechanical degrees.

However, between about 135° and 180°, the developing flux of the magnetic field (see dashed arrows in FIG. 1d) caused by the excitation of the commutating and field-connecting coils 7,8 interacts with the closed-circuit flux loop (solid arrows) caused by the magnetisation of the inner back iron. See the opposite directions of the flux lines in the limb 12c of the back-iron 14. Thus, while the closed loop exists, it reduces the torque developed by the commutated magnetic flux. Hence the drop in torque seen at about 160° in FIG. 6a. Nevertheless, there is a dual effect taking place. On the one hand, the pole 10b progressively “pinches-off” the air gap across which the closed loop flux crosses, so that the negative effect of the closed loop reduces. On the other hand, the pole 10b progressively connects with the commutating pole 11, so that the commutated flux leaving pole 10a and opposing the closed loop flux in limb 12c, increases.

In any event, the effect of the enlarged field pole 12 producing an inner back-iron 14 is that, not only does the rotor park (in either of the FIG. 1c or 1d positions) in a position at which it will start when power is first applied, but also it encourages combining of the fields produced by each source. The effect of this seems to be that the current impulse to force the rotor to deflect from its low reluctance position (ie FIG. 1d) need not be as large as required in the prior art arrangements shown in Figures A to D or exemplified by EP-A-455578 where the fields produced are orthogonal. The power delivery to the rotor is also smoothed, reducing the need for inertial or other smoothing.

It should be emphasised that the motor described above, while showing many of the facets of the present invention, is not within the scope of the invention.

Turning to FIGS. 2a to d, a variation on the FIG. 1 motor is shown which is in accordance with the invention of WO-A-02/101907, in that the rotor 10′ is magnetised, whereas the field pole limbs 12a,b are not. Otherwise this embodiment is identical with FIG. 1, although the driving causes are different.

For example, about 10° after the zero position shown in FIG. 2a, the commutating windings 7 (and field windings 8) are energised to create a north pole at commutating pole 11. This repels the rotor 10′ in the direction of rotation (Arrow A). At about 45°, a reluctance effect in the developing magnetic short-circuit through the inner back-iron 14 produces further driving torque (beyond what it would have been without it as shown in phantom lines in FIG. 6b). This diminishes at about 90°, however, when the short-circuit is complete. On the other hand, at this point, the south pole 10b of the rotor 10′ is now attracted by the north commutating pole, which attraction increases between 135° and 190°. Such increase would normally also increase the torque felt by the rotor (dashed line in FIG. 6b) except that, at this phase, the low reluctance effect of the magnetic short-circuit (arrows, FIG. 2d) is being broken. At about 190°, the current through the field windings 7,8 is reversed to present a south pole at the commutating pole 11. Thereafter, the cycle is repeated in reverse but leading to the same shape of torque curve.

As can be seen from the curve in FIG. 6b, there is some smoothing of the torque applied to the rotor.

Although the invention of WO-A-02/101907 works, in principle, with a two-pole rotor, the arrangements shown in FIGS. 3 and 4 are preferred because, over 180° of mechanical rotation, twice as many peaks and troughs in the torque curve are experienced. For the same inertial mass of rotor, this will lead to smoother rotation, despite the fact that the electrical circuit required is the same.

In FIG. 3a, a four-pole rotor 10″ is in the form of a cross and is magnetised to present alternating north and south poles 10a,b,c and d around the cross. Each pole is stepped or curved (not shown), as in the embodiments of FIGS. 1 and 2, to present a variable air gap for rotation direction control.

When the coils are energised in the FIG. 3a position, each commutating pole 11″ presents a north magnetic pole to the north poles of the rotor 10″. This repels the two north poles 10a,c of the rotor and so the rotor moves clockwise. The inner back iron 14 now starts to provide a low reluctance path between the north and south pole pairs 10a,b and 10c,d of the rotor 10″.

The rotor rotates to a position of minimum reluctance, a few degrees clockwise beyond the position shown in FIG. 3b. This will naturally occur with or without energisation from the stator windings. When the rotor is at the position shown in FIG. 3b the stator coils are energised (if not already—that is to say, if turned off for a period between the FIGS. 3a and b positions) so that a north pole is present at the airgap surface of commutating poles, 11. Now the south poles of the rotor are attracted to the commutating poles. The method of torque production at this step is by a combination of electromagnetic alignment torque and reluctance torque.

With the rotor in the position as shown in FIG. 3c, the current in the stator windings is reversed as quickly as possible. This impulse in the magnetic field ‘kicks’ the south poles of the rotor by applying an opposing field and thus pushes the rotor again with a clockwise rotation. The process is repeated for every 90 degrees of rotation, but each time the directions of current are reversed. As with the previously discussed embodiments, one electrical cycle may be seen to occur every 180° of mechanical rotation. The reversal of the field in the commutating poles may describe this machine as a reciprocating flux impulse motor.

A simpler version of the motor (not in accordance with the invention) is shown in FIG. 4, where the field in the commutating poles and back iron is unidirectional (ie, it does not reverse), and the inner iron ring 14″ possesses a magnetisation as shown. This arrangement corresponds with the FIG. 1a to d embodiment of the present invention. Here the inner iron has a four-pole magnetisation to attract the four-poles of the rotor when at rest.

Also, for a four-pole rotor, a two-pole magnetisation may also be applicable as shown in FIG. 5. However, with this arrangement, the permanent field in the inner iron 14′″ will be shared with the back iron 13′″.

When current is applied to the coils 8,9, the commutating poles will attract the poles of the rotor. The direction of current is important as this will enhance the permanent field in the inner back iron or try to oppose it and may affect the torque production mechanism at commutation. However, if sufficient ampere-turns is applied, the commutating poles will attract the nearest rotor poles and (mostly) reluctance torque will be produced. As there is a variable air gap between the commutating poles 11′″ and the rotor poles 10′″, the commutating poles will pull the rotor to a position similar to that shown in FIG. 3a.

Upon releasing the current, the rotor will continue to rotate clockwise due to the permanent magnetisation of the inner iron. As there is no permanent magnetisation of the rotor 10′″, the commutating current may be unidirectional. This applies also to the FIG. 4 arrangement.

Typical electrical drive circuits for the reciprocating flux impulse motor (ie the embodiments of FIGS. 2 and 3) are shown in FIG. 7. FIG. 7a shows an arrangement using two transistor switches 16, allowing a bi-directional field to be produced using a bifilar winding 15a,b for the commutating and field coils 8,9 respectively. Alternatively, a bi-directional field may be produced using an H-bridge arrangement shown in FIG. 7b.

For the reciprocating flux impulse motor to function satisfactorily the rapid reversal of the flux is important. This can be achieved by the circuit in FIG. 7a which employs a snubber arrangement 17 to controllably allow the turn-off voltage across the switch 16 to rise to a maximum voltage. Thus this large voltage opposes the inductive current in the winding and so rapidly forcing it to zero. Simultaneously turning on the other switch allows the field to build up in the other direction. The stored energy absorbed during the turn-off of the first switch may be used to forcibly and rapidly increase (or ‘kick-start’) the current in the other winding, rather than simply allowing the current to steadily build up with a normal supply voltage. This is because the stored energy can be arranged to be at a much higher voltage than the voltage of the power supply.

Alternatively, the stored energy in the snubber 17 can just be returned to the supply, rather than being dissipated in a resistance. In either case the snubber circuit is said to be regenerative, where the recovered energy is not lost, and is, therefore, more efficient than a conventional RCD (resistor-capacitor-diode) snubber.

A typical circuit for the simple (unidirectional) flux impulse motor of FIGS. 1, 4 and 5, is shown in FIG. 8 using only a single winding, 15, a single switch, 16, and a snubber circuit that may be regenerative.

In both types of motor the firing of the drive circuit is synchronised to the rotor position relative to the stator by a suitable encoder. On the other hand, it is envisaged that sensorless techniques may be used to achieve the same objective.

Turning to FIGS. 9 and 10, the unidirectional flux impulse motor (not in accordance with the present invention) has parking magnets (N) in the inner iron of the stator, as shown in FIG. 9a. When commutation is about to take place, the direction of the magnetic field in the commutating poles 11 affects the torque producing mechanism of the rotor. If the parking magnets present ‘north’ poles into the airgap of the motor and the direction of the current in the coils allows the commutating poles to be ‘south’ poles at the airgap then the magnetic flux path in the motor is shown in FIG. 9a. It can be seen that the field due to the magnets and the field due to the commutating poles are coincident and the net attractive force on two of the rotor poles is great. The rotor is forced to move to a position as shown in FIG. 9b. At this point the other two neighbouring poles of the rotor are approaching the vicinity of the parking magnets. Instead of the rotor stopping at the position shown in FIG. 9b, the magnetic field finds a new (lower reluctance) path via the neighbouring poles, (see FIG. 9c). Motoring torque is maintained in the situation of FIG. 9c, where the neighbouring poles of the rotor are being pulled into alignment with the combined field passing through the magnets.

If, however, the current in the coils is in the reverse direction, such that the commutating poles presented ‘north’ magnetic poles to the airgap (like the magnets) then the magnetic fields due to the magnets and the stator excitation will not be coincident. Instead, they will seek independent paths throughout the iron of the motor, (see FIG. 10). This situation does not effectively and efficiently commutate the motor and may result in stalling the machine. This arrangement should therefore be avoided.

The flux impulse motor of the present invention may typically operate as a variable speed drive utilising one or two power transistors to commutate the current in the commutating winding. Other arrangements are possible using more than two transistors including the possibility to commutate the field winding current, but this adds complexity and cost to the drive. The speed of the machine is controlled by either varying the magnitude or duration (or both) of the current in the commutating winding (and possibly the field winding). The effect is to control the magnitude of the torque producing impulse of flux at the commutating poles. The magnitude of the current is varied by chopping the current (usually at some high frequency). This may cause starting problems though, so phase angle control of the current is an alternative (if not a preferred) option. Phase angle control operates by introducing a variable delay at turn-on of the current in the commutating winding. This delay is typically zero at start-up and is increased to achieve the desired operating speed. This may be achieved by utilising some form of closed loop feedback control system.

Turning now to the present invention, an embodiment of which is illustrated in FIGS. 11a and b, the motor is substantially identical in fundamental construction and operation to that described above with reference to FIGS. 3a to c, and accordingly like reference numerals are employed for equivalent components.

Thus, motor 1 has a stator 2 defining an outer back iron 13 and commutating poles 11 and field connecting poles 12. The field connecting poles have an inner back iron 14. A rotor 10 is cross shaped (in this embodiment) having poles 10a-d. The rotor 10 rotates about a central rotor axis 50, clockwise, in the drawings, in the direction of the arrow A.

Each rotor pole has an end face 54 that is circular, centred at a point 50a eccentric to the rotor axis 50, and so that a leading section 54a is closer to the rotor axis 50 than a trailing section 54b. The radius R_{L} of rotation of the leading edge 56 of the rotor is about 4% less than the radius R_{T} of rotation of the trailing edge 58 of each rotor pole 10a-d. Although shown as a smooth circular profile, the end face 54 of each rotor pole could be stepped, as shown in FIGS. 1a-d, or FIG. 3b.

Each pole has a width W between generally parallel sides 62,64. The width W is about 50% of the diameter of the rotor 10. Across the majority of the width, in a slot 70 formed in each rotor pole, is disposed a permanent magnet 72 which is parallel magnetised across its major faces.

The rotor 10 is a stack of laminations, each being cross-shaped and having the slot 70 stamped from it. A ligament 71 at each end of the slot joins a proximal root 73 of the rotor 10 and a distal pole tip 75. As is clearly visible by the circular arrows, the ligaments 71 short-circuit the flux from the ends of magnet 72 and diminish its effectiveness. Consequently, the ligaments are as narrow as possible, so that it takes little flux to saturate them, forcing the remaining flux to exit the rotor 10, mostly through the end face 54.

The slot 70 is inclined with respect to the tangent of the circle circumscribed by the rotor and which is perpendicular to the radial axis 82 of each rotor pole. The angle of inclination is β and is about 20°.

The slot 70 is formed so that it extends from near the trailing edge 58 of the trailing side 62 of the rotor pole to near the root 84 of leading side 64 and trailing side 62 of the adjacent rotor pole.

The effect of the inclination of the magnet 72 is to present the trailing edge with a saturation of magnetic flux so that it has high reluctance as regards accepting more flux. Conversely, the leading edge 56 of each rotor is unsaturated, and this is illustrated by the flux lines 90 shown concentrated at each trailing edge 58. This biases the rotor 10 so that it will preferentially rotate in the clockwise direction on start up from any rotational position of the rotor. This enhances the effect of the reducing diameter (2R_{T} to 2R_{L}) of the rotor in the direction of rotation as described above.

However, another effect of the inclined magnet is that, despite its ends being decommissioned by virtue of their short-circuiting by the ligaments 71, the length (in the sense of length in the direction of the width W of the rotor poles) of the magnet can be increased, so that the flux passing out of the end face of the rotor is substantially as much as if a magnet was disposed tangentially with respect to the rotor axis, spanning the width W of the rotor pole, but not having any ligaments to short-circuit it.

Fitting the magnets in slots 70 is a very convenient disposition for them, as they require no additional retention or securing. Indeed, even axially, they will not easily be dislocated once fitted, since their magnetic effect keeps them in position. If they are a tight sliding fit in the slots 70, then mere pressing into the slots, even with thin ligaments 71, is adequate retention that is reinforced by the magnetisation of the magnets. Such an arrangement could be employed even when the magnets are tangential, which would be the case, for example, where dual starting directions may be preferred and no bias is desired. In this event, another means to compensate for the loss of magnetic effect caused by the ligaments might be required, such as by broadening the root 73 of the rotor pole so that wider magnets may be inserted.

Turning to FIG. 11b, each inner back iron 14 has a root 14a, leading wing 14b and trailing wing 14c. The inner surface of the inner back iron 14, facing the rotor 10, is generally circular, centred on the axis 50. The angular extent of the inner back iron 14 (between radii 96,98 passing through the leading and trailing tips respectively of section 14b of the inner back iron 14), as described above for a motor with a four-pole rotor, is about 135° (270/n). Radius R₁ of the inner back iron is as close to radius R_{T} as possible, and generally will be within 1 or 2 mm, depending on manufacturing tolerances.

The inner surface of the inner back iron 14 is divided into three sectors: a leading sector 14L, a trailing sector 14T and an intermediate sector 14N. A leading junction LJ lies between leading sector 14L and intermediate sector 14N, and a trailing junction TJ lies between trailing sector 14T and intermediate sector 14N. Trailing junction TJ is substantially in the centre of root 14a, on radius 94. Leading junction LJ is substantially on the radius 100 bisecting radii 94 and 96.

The radius R₂ of the intermediate sector 14N is between 2 and 4%, preferably about 3%, greater than the radius R₁.

Referring to FIG. 11a first, the rotor, as mentioned above, is rotating clockwise. Consequently, as the leading edge 56 of rotor poles 10a and c begin to pass over the leading junctions LJ of the respective inner back irons 14 of the field connecting poles 12, the air gap experienced by the rotor progressively increases, progressively increasing the reluctance of the magnetic connection between poles 10c,d on the one hand and 10a,b on the other with their respective inner back irons. This has the effect of retarding the rotor. Such retardation occurs, however, at the same time electromagnetic torque generated by the attraction between commutating poles 11 and rotor poles 10b,d is at its maximum. Consequently the effect is to soften the acceleration of the rotor.

Conversely, as the leading edge 56 passes over the trailing junction TJ, the reluctance progressively decreases accelerating the rotor through the position shown in FIG. 11b. This acceleration coincides with the loss of electromagnetic driving torque of the commutating motors in this position as the current in the stator coils switches.

The overall effect, therefore of the intermediate sector 14N is a smoothing of the torque developed by the motor 1.

1. A motor comprising
a stator;
a rotor mounted for rotation about a rotor axis in the stator;
a pole of the stator;
a winding on the stator pole;
at least one pair of salient poles of the rotor, the rotor being magnetised so that said rotor poles are oppositely magnetised;
an electrical circuit being provided with control means to produce an alternating magnetic field in the pole of the stator to attract each pole of the rotor as it approaches the pole and to repel each pole of the rotor as it moves away from the pole, said field alternating as many times per revolution of the rotor as there are poles of the rotor; and
each pole of the rotor being magnetised by a permanent magnet carried by said pole; wherein
the magnet is disposed in a transverse slot in each pole.

2. A motor as claimed in claim 1, wherein said rotor comprises a stack of laminations connected together

3. A motor as claimed in claim 2, wherein, in a cross section of the rotor perpendicular to said rotor axis, said slot is closed.

4. A motor as claimed in claim 1, wherein, in cross section in a plane including said rotor axis, said magnet is parallel said rotor axis.

5. A motor as claimed in claim 1, wherein, in cross section in a plane perpendicular said rotor axis, said magnet is inclined with respect to a tangent of the circle that is centred on the rotor axis, which tangent is that perpendicular to the radius that passes through the centre of the pole, said angle of inclination being between 5° and 40°.

6. A motor comprising
a stator;
a rotor mounted for rotation about a rotor axis in the stator;
a pole of the stator;
a winding on the stator pole;
at least one pair of salient poles of the rotor, the rotor being magnetised so that said rotor poles are oppositely magnetised;
an electrical circuit being provided with control means to produce an alternating magnetic field in the pole of the stator to attract each pole of the rotor as it approaches the pole and to repel each pole of the rotor as it moves away from the pole, said field alternating as many times per revolution of the rotor as there are poles of the rotor; and
each pole of the rotor being magnetised by a permanent magnet carried by said pole;
characterised in that
in cross section in a plane perpendicular said rotor axis, said magnet is inclined with respect to a tangent of the circle that is centred on the rotor axis, which tangent is that perpendicular to the radius that passes through the centre of the pole, said angle of inclination being between 10° and 40°.

7. A motor as claimed in claim 6, wherein said angle of inclination is between 10° and 30°.

8. A motor as claimed in claim 7, wherein said angle of inclination is between 15° and 25°.

9. A motor as claimed in claim 6, wherein, in a cross section of the rotor perpendicular to said rotor axis, said rotor pole has a width across the radius that passes through the centre of the pole, and said magnet extends across most of the width of said rotor.

10. (canceled)

11. A motor as claimed in claim 6, wherein said rotor has an end face and sides defining leading and trailing corners of the rotor in the direction of rotation of the rotor.

12. A motor as claimed in claim 11, wherein said magnet has one end adjacent said trailing corner, whereby the magnetisation of the magnet magnetically saturates the rotor in the region of said trailing corner, and another end which is spaced from the leading corner which is not magnetically saturated.

13. A motor comprising:
a stator;
a rotor mounted for rotation about a rotor axis in the stator;
first and second poles of the stator;
a winding on at least one of the stator poles;
at least one pair of salient poles of the rotor, the rotor being magnetised so that said rotor poles are oppositely magnetised;
an outer back-iron magnetically joining said stator poles;
an inner back-iron, extending from at least one of said stator poles around the rotor so that the magnetic field in the rotor between adjacent poles of the rotor is substantially short-circuited by said inner back-iron for a part of the rotation of the rotor; and
an electrical circuit to power the winding to drivingly rotate the rotor; wherein
said first pole of the stator is a commutating pole and does not short-circuit the rotor;
said second pole of the stator is a field connecting pole (12) and has said inner back iron;
said electrical circuit is provided with control means to produce an alternating magnetic field in the commutating pole of the stator to attract each pole of the rotor as it approaches the commutating pole and to repel each pole of the rotor as it moves away from the commutating pole, said field alternating as many times per revolution of the rotor as there are poles of the rotor; whereby
the rotor is driven by a combination of electromagnetic torque through interaction between the rotor and the commutating pole and by reluctance torque through interaction between the rotor and the field-connecting pole,
characterised in that
the inner back iron is substantially circumferential with respect to the rotor axis and has end sectors adjacent its ends and an intermediate sector between said end sectors, which intermediate sector is spaced further from said rotor axis than said end sections.

14. A motor as claimed in claim 13, wherein most of said intermediate sector is in a leading part of said inner back iron with respect to the direction of rotation of the rotor.

15. A motor as claimed in claim 13, wherein said end sectors are a leading end sector and a trailing end sector with respect to the direction of rotation of the rotor and said intermediate sector has a trailing junction with said trailing sector, which trailing junction is on the radius of said rotor axis passing through said field connecting pole.

16. A motor as claimed in claim 15, wherein said trailing junction is on the radius of said rotor axis passing through the centre of said field connecting pole.

17. A motor as claimed in claim 15, wherein said intermediate sector has a leading junction with said leading end sector positioned so that the circumferential extent of said intermediate sector is between 70% and 130% of the circumferential extent of said leading end sector.

18. A motor as claimed in claim 17, wherein said circumferential extent of said intermediate sector is between 90% and 110% of the circumferential extent of said leading end sector.

19. A motor as claimed in claim 13, wherein said rotor has an end face having a leading section extending from a leading edge of said rotor with respect to the direction of rotation of said rotor, and a trailing section extending from a trailing edge of said rotor with respect to the direction of rotation of the rotor.

20. A motor as claimed in claim 19, wherein said leading section is spaced nearer said rotor axis than said trailing section.

21. A motor as claimed in claim 19, wherein said end face is a circular arc centred on an axis parallel to and spaced from said rotor axis.

22. A motor as claimed in claim 19, wherein the radius of said trailing section is between 2% and 10% more than the radius of said leading section, preferably between 3% and 6%.

23. A motor as claimed in claim 22, wherein the radius of said trailing section is between 3% and 6% more than the radius of said leading section.

24. A motor as claimed in claim 19, wherein said trailing edge defines a minimum air gap between the rotor and inner back iron, which air gap, when said trailing edge is adjacent either end sector, is between 20% and 70% of the air gap when said trailing edge is adjacent said intermediate sector, preferably between 40% and 60%.

25. A motor as claimed in claim 24, wherein said minimum air gap, when said trailing edge is adjacent either end sector, is between 40% and 60% of the air gap when said trailing edge is adjacent said intermediate sector.

26. A motor as claimed in claim 13, wherein the radius of said intermediate sector is between 1% and 3% more than the radius of said end sectors.

27. (canceled)

28. (canceled)

29. (canceled)

30. A motor as claimed in claim 3, wherein, in a cross section of the rotor perpendicular to said rotor axis, said rotor pole has a width across the radius that passes through the centre of the pole, and said magnet extends across most of the width of said rotor.

31. The motor of claim 30, wherein ligaments of each rotor lamination define each end of the slot, said ligaments being sufficient to support a distal pole tip art of each lamination with respect to a proximal root of each lamination and retain the magnet in the slot while minimizing the flux short-circuiting of the magnet caused by said ligament.
